(19) United States
(12) Patent Application Publication
(10) Pub. No.: US 2008/0023667 A1
(43) Pub. Date: Jan. 31, 2008

(54) Fluoride tile etchants having improved safety

(76) Inventors: Fred N. Miekka, Arcadia, CA (US); Jason E. Twebell, Glendora, CA (US)

Correspondence Address: FRED MIEKKA, 757 SOUTH GOLDEN WEST AVE, ARCADIA, CA, 91007, US

(21) Appl. No.: 11/820,048

(22) Filed: Jun. 18, 2007

Related U.S. Application Data
(60) Provisional application No. 60/814,745, filed on Jun. 19, 2006.

(51) Int. Cl. C09K 13/06; C09K 13/04; C09K 13/08

(52) U.S. Cl. 252/79.3; 252/79.1; 252/79.2; 252/79.4

(57) ABSTRACT

Aqueous based tile etching solutions are disclosed containing hydrofluoric acid along with additives that can be used to reveal exposure. The exposure revealing additives of the present invention may have irritant properties so that an exposed individual can feel that skin contact has occurred and/or alternatively may dye the skin to reveal a colored or fluorescent stain where contact has taken place. The result is a hydrofluoric acid containing tile etching solution having improved overall safety by revealing when and where exposure has taken place. This becomes very important owing to the fact that skin contact with solutions containing hydrofluoric acid often go unnoticed for some time and may therefore result in substantial chemical injury including bone damage. The hydrofluoric acid employed in the present invention may be formed in situ by the interaction of a strong acid with a water soluble fluoride salt.

### CROSS-REFERENCE TO RELATED APPLICATIONS

This non-provisional application claims benefit of the provisional application filed on Jun. 19, 2006 having application No. 60/814,745.

### BACKGROUND OF THE INVENTION

1. Field of the Invention

This invention relates to tile etching and more particularly this invention relates to improving the safety of tile etching solutions containing hydrofluoric acid.

2. Description of the Related Art

Tiles used in flooring surfaces offer numerous advantages. These advantages include ease of cleaning, resistance to abrasion, and fire safety. Generally speaking in the event of fire ceramic and clay tiles employed in flooring do not release toxic smoke, are not flammable, and do not melt and stick to the feet the way that nylon carpets do. In addition, flooring tiles do not capture and hold allergens such as pet dander and pollen and are resistant to mould growth. There are however some drawbacks to tiles employed in flooring applications. Of particular interest is the tendency of flooring tiles to become slippery when wet. Additionally, flooring tiles form a hard surface that may result in severe injuries from slips and falls. Because of this, it is common practice to place throw rugs in areas of high foot traffic. These throw rugs tend to be small and therefore are relatively easy to clean. When employing such throw rugs it is important to prevent the throw rug from sliding against tile surfaces as this sliding may contribute to slips and falls as well.

There are numerous coatings that may be applied to the exposed surfaces of wet flooring tiles to render them less slippery. Some of these coatings may include the addition of hard, rough, and abrasive materials such as sand. One or more binders may be employed to hold the abrasive material to the flooring surface. These anti-slip coatings may be in complete form ready to use or alternatively a binding agent may be applied to the exposed surfaces of flooring tiles followed by the addition of the abrasive material in granular form. Once the coating is dry, excess abrasive may then be removed and discarded.

While effective at increasing the anti-slip properties of flooring tiles these coatings may be excessively rough and tend to wear off relatively quickly. This may be especially true when employed in areas of high foot traffic such as in hotel lobbies and restaurant dining areas.

While special coatings may be applied to tiles to provide anti-slip properties, forming tiles in situ allows individuals to add anti-slip materials to the surface of the freshly cast tiles so that they will become part of exposed tile surfaces on hardening. Additionally, forming tiles in situ enables individuals the ability to use materials like cement that naturally have some anti-slip properties.

One particularly interesting approach for forming tiles in situ is outlined in U.S. Pat. No. 4,932,182 awarded to John R. Thomasson titled “Floor Tile Forming and Structural Underlayment Device”. A one piece plastic molded sheet having special entrapping designs is used to cast tiles in situ. This approach is especially appealing due to its versatility. The mold entrapping designs prevent the release of the cast tiles thereby eliminating the need to cement individual tiles to the floor. Tile spacing is provided by the mold with raised portions giving the appearance of tile grout. This system allows the person laying down tiles to cast their own tiles out of a wide variety of materials.

One particularly interesting approach to reduce the slip level of wet tiles is to etch them with a chemical. There are numerous materials that may be employed to etch the surfaces of tiles in order to improve grip. Of particular interest is the use of tile etching solutions to improve the grip between a wet tile surface and the soles of footwear. Such treatment options may be specific to particular tile materials or alternatively may have broad application. For example, hydrochloric acid (sometimes called muriatic acid) is an aqueous solution containing dissolved hydrogen chloride gas. This acid is particularly strong owing to the fact that the hydrogen ions are only loosely associated with the chloride ions in solution. The loose hydrogen ions in solution may be attached to water molecules forming hydronium ion. Hydronuim ions are good at attacking numerous alkaline materials such as marble (calcium carbonate) and certain calcium and/or magnesium containing components in cement. Because of this, hydrochloric acid is often employed in the preparation of cement surfaces. Aqueous solutions containing considerable amounts of hydrochloric acid have a marked tendency toward rapidly dulling marble surfaces to which they may be applied and therefore are not always recommended. In addition, hydrochloric acid is somewhat volatile and may release substantial amounts of hydrogen chloride gas on standing or drying. Hydrogen chloride gas is an irritating vapor that can easily rust steel surfaces. Because of this, the use of hydrochloric acid for the surface etching of tiles may be somewhat limited in nature.

Hydrochloric acid may be considered to be a strong acid. Other strong acids include phosphoric acid and sulfuric acid. A strong acid is an acid that when placed in water forms a significant portion of hydrogen ions or hydronium ions (hydronium ions are hydrogen ions having a water molecule attached to them).

Hydrofluoric acid may be employed for etching tile surfaces with considerable success. Hydrofluoric acid is a weak acid (forms little hydrogen or hydronium ion in the presence of water) despite this fact, hydrofluoric acid attacks a significant number of mineral based materials including ceramic, glass, and clay. In addition, because hydrofluoric acid is a weak acid, it will rapidly form in solution if a strong acid such as sulfuric or phosphoric is mixed with an aqueous solution of a fluoride salt.

Hydrofluoric acid surface treatments of mineral based tiles may produce channels that significantly increase the wet grip toward other surfaces. It should be noted that these channels may be deep enough to provide good wear resistance. The result is a wear resistant surface treatment that significantly improves the wet gripping properties to a variety of contacting substrates such as rubber and leather commonly employed on the bottom of footwear surfaces.

Because hydrofluoric acid has a strong affinity for calcium and silica, the concentration of hydrofluoric acid in aqueous based tile etching solutions only needs to be on the order of a few percent. It should be noted that adding an excess of a strong acid such as sulfuric or phosphoric to an aqueous solution of a fluoride salt will completely convert any available fluoride ion to hydrofluoric acid and will then rapidly lower the solution pH.

Mr. John Howard developed a hydrofluoric acid based tile surface treatment solution in the early 1990's. His work was carried out at the British Columbia Research Institute. His anti-slip tile treatment solution contains about three percent hydrofluoric acid in aqueous form. His system consists of the following:
1. A prep cleaner for pre-cleaning flooring tile surfaces prior to hydrofluoric acid etching,
2. Aqueous hydrofluoric acid etching solution containing about 3% hydrofluoric acid
3. A neutralizing solution containing silicates
   Mr. John Howard's etching system is very effective owing to the high reactivity of hydrofluoric acid toward both calcium and silica based minerals.

Unfortunately while effective in etching tile surfaces, hydrofluoric acid presents certain specific handling hazards and may cause significant tissue destruction and bone damage without the persons awareness. There is thus a need for tile etching solutions containing hydrofluoric acid that quickly notify the user that exposure has taken place.

It is an object of this invention to reduce the slip and fall hazard of wet flooring tile surfaces.

It is a further object of this invention to provide a non slip-floor tile treatment that has good wear resistance.

It is a further object of this invention to provide a low cost way of treating existing flooring tile surfaces

Finally, it is an object of this invention to provide a non-slip flooring tile treatment employing hydrofluoric acid along with additives that reveal when skin contact exposure has taken place.

### SUMMARY OF THE INVENTION

This invention therefore proposes aqueous tile etching solutions containing hydrofluoric acid along with additives that notify the user of exposure. These tile etching solutions can be used to treat a wide variety of tile surfaces such as clay and ceramic. The resulting treated non-slip surfaces exhibit good anti-slip properties when wet and have good wear resistance.

### DETAILED DESCRIPTION

As mentioned earlier, aqueous solutions of hydrofluoric acid will etch ceramic and clay tile surfaces. The concentration of hydrofluoric acid required for a good etch is on the order of 3 percent. At this concentration, a good etch will take place within an hour. After this timeframe the tile surface may then be rinsed clean and subsequently dried off. The resulting tile surface may look slightly duller but other than that the appearance may not have changed significantly.

Hydrofluoric acid has a tremendous reactivity toward calcium. This may be due at least in part to the exceedingly low solubility of calcium fluoride (fluorospar). Calcium is found all over the human body. It regulates many biological systems and is needed in ionic form for proper functioning. In addition, the bones contain much calcium in the form of phosphates. Hydrofluoric acid has an insidious property of slowly penetrating into the skin and subsequently migrating deeply into tissues even attacking bone. Burns associated with hydrofluoric acid may not become evident for several hours. During this timeframe, hydrofluoric acid may be burning deeper and deeper into underlying tissues and bone. In addition to tissue and bone destruction, calcium depletion may result in numerous health problems. Kidney damage may also occur. Long term exposure to even relatively small amounts of fluoride ion and/or hydrofluoric acid may result in fluorosis.

The insidious nature of hydrofluoric acid to cause damage over several hours coupled with the fact that an exposed individual may be unaware of the problem necessitates the need to bring immediate exposure awareness to individuals using tile etching solutions containing fluoride ion and/or hydrofluoric acid. There are two primary reasons why individuals working with hydrofluoric acid may not be aware that exposure has taken place.

1. Burns may not be visible for some time.

2. Burns may not be felt for some time.

In order to help remedy these issues, additives and/or modifications to the etching solutions may be carried out.

Visibility of exposure may be significantly improved by the addition of certain dyes to tile etching solutions containing fluoride ion and/or hydrofluoric acid. This is particularly true for dyes that have an affinity for binding to the skin. These dyes may be visible in ambient light or alternatively they may be visible only under black light. Visible dyes may be employed that are unstable in the presence of bleach or other reactive chemical materials so that they may be later decolorized and therefore not stain tile surfaces.

Gentian violet is a visible dye having a purple color. It has been used as a skin disinfectant. A one percent solution may be applied to the skin as an antiseptic for the external treatment of abrasions, minor cuts, and surface injuries. One particular distributor of gentian violet for skin disinfectant purposes is De La Cruz Products Division of DLC Enterprises, Inc. Paramount, Calif. 90723 USA.

Gentian Violet will rapidly stain the skin on contact. This stain will eventually fade over several days (especially if the stain is washed repeatedly with soap and water). Gentian Violet like many dyes is rapidly decolorized by ordinary household bleach (a water solution of sodium hypochlorite of about 5% concentration).

Fluorescent brighteners are materials that absorb ultraviolet light and emit visible light at wavelengths that compensate for yellow colors found in certain fabrics such as cotton. Fluorescent brighteners may form chemical bonds to the fabric so that they do not wash off. Of particular interest are the coumarin based fluorescent brighteners. One brightener in particular, Tinopal SWN by Ciba-Geigy is a coumarin based fluorescent brightener chemically known as 7-diethylamino-4-methylcoumarin.

A 0.2 gram quantity of 7-diethylamino-4-methylcoumarin was placed into a 250 milliliter Erlynmeyer flask. To this were added 90 grams of distilled water along with 10 grams of concentrated phosphoric acid. The mixture was stirred for several minutes to dissolve the solid. Some solid remained at the bottom of the flask indicating that this particular compound is difficult to dissolve in the above described mixture. A cotton swab was used to apply a small amount of this mixture to the skin. After one minute, the area of application was inspected for fluorescence with a black light. Fluorescence was significant. The area was then rinsed off with water. The result was a slightly lighter but very persistent fluorescent stain. Further rinsing did little to reduce the level of fluorescence. The intensity of the stain was then observed over a timeframe of a few days. During this timeframe the stain faded away.

The ability of this particular brightener to stain the skin in the presence of acids makes it a good candidate for addition to acid containing fluoride based tile etching solutions. The addition of skin staining fluorescent brighteners such as Tinopal SWN to tile etching solutions containing hydrofluoric acid in combination with follow up procedures using black light illumination represents a significant step forward in the safe handling of these very useful and effective tile etching solutions.

The next area to be addressed is irritation. Irritation is natures way of telling you that something is wrong and needs to be addressed. If hydrofluoric acid was a strong acid that hydrolyzed in water to form mostly hydrogen ion (hydronium ion in excess water) the hazard level of hydrofluoric acid may be reduced. If you spilled some of the solution on your skin it would tend toward rapid irritation, itching, inflammation, irritation, and discoloration. You would be more keenly aware that exposure occurred and within a short timeframe you would be able to wash the area off with little resultant damage. Unfortunately, hydrofluoric acid is a weak acid that may slowly migrate into the skin and underlying tissues undetected. The insidious nature of hydrofluoric acid is a major contributing factor that makes it so dangerous to handle.

It should be noted that in many respects hydrofluoric acid on a chemical level behaves similar in nature to ordinary water. Both water and hydrogen fluoride may be formed by reacting hydrogen with a more electronegative element, exhibit hydrogen bonding properties, are inorganic covalently bonded compounds having considerable polarity, and have very high negative heats of formation with respect to their starting elements. The similarities between hydrofluoric acid and water especially with respect to their hydrogen bonding properties may help to explain the ease with which hydrofluoric acid penetrates aqueous laden epithelial tissues.

Another similarity between hydrofluoric acid and water resides in a particular compound known as ammonium bifluoride. Ammonium bifluoride is the acid salt of ammonium fluoride and hydrofluoric acid. The name ammonium bifluoride may be somewhat misleading. Strictly speaking, that chemical name should represent NH4HF. Since the ammonium ion has a poly atomic valence of +1, and fluoride ion has a valence of −1, there is no room for the extra hydrogen and therefore this chemical formula does not correctly represent ammonium bifluoride. The correct formula for ammonium bifluoride is NH4FHF. This represents ordinary ammonium fluoride NH4F that has been hydrated if you will not with water but rather with waters substitute hydrofluoric acid. It may be that covalently bonded polar hydrofluoric acid is acting as a crystallization stabilizer to ammonium fluoride. Hydrogen bonding along with polar forces may contribute to the incorporation of hydrofluoric acid in the crystals.

Significant focus and attention has been paid to the use of ammonium bifluoride in etching formulations. This may be due in part to the fact that it is readily available and is a good source of hydrofluoric acid in solid form. Ammonium bifluoride itself is dangerous and needs to be handled with respect. The reason for this is that ammonium bifluoride consists of ammonium ion, fluoride ion, and hydrofluoric acid tied up in a crystalline lattice. The fluoride ion and the resulting hydrofluoric acid need to be respected for their inherent dangers and subsequent hazards associated with their handling.

Ammonium bifluoride will hydrolyze if placed into water releasing a significant amount of free hydrofluoric acid. If such a solution is then acidified with a strong acid such as sulfuric or phosphoric acid, free fluoride ion will rapidly bond with hydrogen ions forming more hydrofluoric acid in situ. Strong acids such as sulfuric acid can irritate the skin at relatively low concentrations, furthermore such acids may be used to enhance the effects of tile etching solutions containing hydrofluoric acid. Tile etching solutions may be prepared that contain hydrofluoric acid and a strong acid such as sulfuric acid. Increasing the sulfuric acid concentration may enhance skin irritation properties. This irritation enhancement may help to reduce the need for additional irritants that give warning of skin exposure by way of irritation. The excess addition of strong acids to such etching solutions may render them capable of etching a wider variety of tile surface materials than the dilute hydrofluoric acid etching solutions of the prior art. Specific non-reactive irritants may be employed such as formic acid, capsaicin, and other materials capable of producing irritating effects on the skin.

Outlined below are examples of tile etching solutions employing aqueous hydrofluoric acid. It should be noted that although no hydrofluoric acid was used in their preparation, the interaction of ammonium bifluoride with the strong acid ingredients produces hydrofluoric acid in situ.

This first example demonstrates the effectiveness of an aqueous hydrofluoric acid based tile etchant on ceramic tiles.

In a clean plastic container were placed 5.0 grams of ammonium bifluoride crystals along with 85.0 grams of distilled water. The resulting mixture was then stirred until dissolving was complete. To this solution were slowly added 10.0 grams of concentrated phosphoric acid (85%) while stirring.

The above described solution was applied to the top surface of several ceramic flooring tiles and allowed to sit undisturbed for 30 minutes at room temperature. After this timeframe, the tile was rinsed off and subsequently allowed to air dry. The etched areas of the tiles appeared slightly duller than the non-etched areas. Running the fingers over the dry surface revealed little difference. The tiles were then wet down with water. This time the gripping properties were significantly higher for the treated verses the non treated tiles.

The previous experiment was repeated using 15.0 grams of phosphoric acid. Similar results were obtained.

The first experiment was repeated with the addition of a skin labeling fluorescent brightner (0.1 grams of 7-diethylamino-4-methylcoumarin). The results were substantially the same.

The second experiment was repeated with the addition of a skin labeling fluorescent brightener (0.1 grams of 7-diethylamino-4-methylcoumarin). The results were substantially the same.

The above described examples provide guidelines for the preparation and subsequent use of hydrofluoric acid based tile etching solutions. The fluorescent brightener employed could be used in varying concentrations to control the relative level of skin fluorescence from a given level of exposure. Had exposure taken place with the solutions containing the fluorescent brightener, visible inspection employing a black light would have revealed the location and extent of any resulting solution contact.

Black lights are electric lights that emit ultra violet light with minimal visible light. Black lights are typically of the fluorescent configuration and may consist of a mercury vapor discharge that emits substantial amounts of ultra violet light in the near visible spectrum. Many black lights are configured to maximize this light while filtering out both visible light as well as harmful shorter wavelengths that may be below about 350 nanometers. Such black lights may be used to detect fluorescent residues left on the skin after exposure to the fluorescent skin staining dyes contained in the fluoride based etchants of the present invention. Small portable battery powered black lights may be used for this purpose.

It should be noted that the acidified form of 7-diethylamino-4-methylcoumarin may provide certain beneficial surfactant properties to etching solutions (its molecular structure does resemble some cationic surfactants).

The phosphoric acid used could be replaced by another strong acid such as sulfuric acid. The source of hydrofluoric acid could come from hydrofluoric acid itself or by the interaction of a water soluble fluoride salt and a strong acid. It should be noted however, that it may be desirable to minimize the amount of toxic hydrofluoric acid in these etching solutions thereby keeping their hazardous properties to a minimum. In that spirit, a working concentration of hydrofluoric acid in these solutions should be kept low at about 3%.

Added irritants such as formic acid can be added directly to these solutions. Addition of formic acid should be done after any strong acids have been diluted down. Certain strong acids such as concentrated sulfuric acid can dehydrate formic acid into water and carbon monoxide. Carbon monoxide is an odorless, tasteless poisonous gas. Organic based irritants having a low water solubility such as hot pepper oil may require the addition of surfactants to help keep them suspended in the mixture.

We claim:

1. A skin staining tile etching solution for providing anti-slip properties to wet flooring tiles comprising:
water;
a strong acid;
a water soluble fluoride salt;
and a skin staining visible dye; whereby said skin staining visible dye is stable to said strong mineral acid and whereby said skin staining visible dye provides a visible stain on the skin on contact with said skin staining etching solution.
A skin staining tile etching solution providing anti-slip properties to wet flooring tiles as recited in claim 1 wherein said strong acid is phosphoric acid.
A skin staining tile etching solution providing anti-slip properties to wet flooring tiles as recited in claim 1 wherein said strong acid is present in a concentration between 5% and 20% by weight and wherein said water soluble fluoride salt is present in a concentration between 1% and 10% by weight.
A skin staining tile etching solution providing anti-slip properties to wet flooring tiles as recited in claim 1 wherein said strong acid stable skin staining visible dye is rapidly decolorized by a water solution of sodium hypochlorite.
A skin staining tile etching solution for providing anti-slip properties to wet flooring tiles as recited in claim 4 wherein said strong acid stable skin staining visible dye that is rapidly decolorized by a water solution of hypochlorite is gentian violet.
A skin staining tile etching solution for providing anti-slip properties to wet flooring tiles comprising:
water;
a strong acid;
a water soluble fluoride salt;
and a skin staining fluorescent dye; whereby said skin staining fluorescent dye is stable to strong mineral acid and whereby said visible dye provides a fluorescent stain on the skin on contact with said skin staining etching solution.
A skin staining tile etching solution providing anti-slip properties to wet flooring tiles as recited in claim 6 wherein said strong acid stable skin staining fluorescent dye leaves a fluorescent stain on the skin on contact with said skin staining etching solution that is visible under a black light.
A skin staining tile etching solution for providing anti-slip properties to wet flooring tiles as recited in claim 6 wherein said strong acid stable fluorescent dye is 7-diethylamino-4-methylcoumarin.
A skin staining tile etching solution for providing anti-slip properties to wet flooring tiles comprising:
water;
a strong acid;
hydrofluoric acid;
and a skin staining dye; whereby said skin staining dye is stable to said strong mineral acid and whereby said skin staining dye provides a stain on the skin on contact with said skin staining etching solution.
A skin staining tile etching solution for providing anti-slip properties to wet flooring tiles as recited in claim 9 wherein said skin staining dye leaves behind a visible stain on the skin on contact with said skin staining etching solution.
A skin staining tile etching solution for providing anti-slip properties to wet flooring tiles as recited in claim 10 wherein said skin staining dye leaving behind a visible stain on the skin is gentian violet.
A skin staining tile etching solution for providing anti-slip properties to wet flooring tiles as recited in claim 9 wherein said skin staining dye leaves behind a fluorescent stain on the skin that is visible under black light on contact with said skin staining etching solution.
A skin staining tile etching solution for providing anti-slip properties to wet flooring tiles as recited in claim 12 wherein said skin staining dye leaving behind a fluorescent stain on the skin that is visible under black light is 7-diethylamino-4-methylcoumarin.
A skin staining tile etching solution providing anti-slip properties to wet flooring tiles as recited in claim 1 further comprising an added skin irritant.
A skin staining tile etching solution providing anti-slip properties to wet flooring tiles as recited in claim 6 further comprising an added skin irritant.
A skin staining tile etching solution providing anti-slip properties to wet flooring tiles as recited in claim 9 further comprising an added skin irritant.
